(19) United States
(12) Patent Application Publication
(10) Pub. No.: US 2006/0288634 A1
(43) Pub. Date: Dec. 28, 2006

(54) Trap for marine life

(76) Inventors: Malcolm Ian Wimbus, Gladstone (AU); Rosemary Joan Wimbus, Gladstone (AU)

Correspondence Address: Hoffman, Wasson & Gitler, P.C., Suite 522, 2461 South Clark Street, Arlington, VA, 22202, US

(21) Appl. No.: 11/439,270

(22) Filed: May 24, 2006

(30) Foreign Application Priority Data
May 24, 2005 (AU) 2005202227

(51) Int. Cl. A01K 69/10; A01K 69/06

(52) U.S. Cl. 43/105; 43/100

(57) ABSTRACT

A trap for marine life including an upper member, a lower member, at least one separating means to retain the upper member spaced from the lower member and defining an opening therebetween, and at least one side wall member movable between a lowered, open condition and a raised, closed condition wherein the wall member substantially closes the opening between the upper member and the lower member.

### FIELD OF THE INVENTION

The present invention relates to traps for marine life and particularly to a trap for fast moving or agile marine life such as crustaceans and particularly prawns and shrimps.

### BACKGROUND ART

Prawns are small marine decapod crustaceans with 10 jointed legs on the thorax, well-developed swimmerets on the abdominal segments, and a body that is compressed laterally. Prawns differ from their close relatives, the lobsters and crabs, in that they are primarily swimmers rather than crawlers.

As with other crustaceans, the body is covered with a smooth exoskeleton that must be periodically shed and re-formed as the animal grows. However, the prawn's exoskeleton tends to be thinner than that of most other crustaceans; it is grayish and almost transparent.

In some areas of the United States the term prawn is loosely applied to any large shrimp. However, in Europe, only members of the genus Crangon, distinguished from other shrimp by a slender body and a depressed abdomen, are considered true shrimp, while decapod crustaceans having toothed beaks (rostrums), long antennae, slender legs, and laterally compressed abdomens are called prawns. Tropical shrimp have bizarre shapes and colors.

Prawns are widely distributed in temperate and tropical salt- and freshwaters. They may grow as long as 23 cm, but most are smaller. They swim forward by paddling their abdominal swimmerets and can move backward with swift strokes of their fanlike tails.

Shrimp are generally caught commercially in large bag like nets that are dragged over the ocean floor, or may be raised in ponds on aquaculture farms. An excellent summary of the known prior art in the field of marine and particularly prawn traps is given in U.S. Pat. No. 5,839,220 and is quoted here verbatim:

“The concept of collapsible crustacean/lobster traps has been around for many years. The key advantage of a collapsible trap is that it permits the user to reduce the trap storage space otherwise needed. Some of the earlier devices using netting and flimsy frames were designed primarily as crab traps for use in shallow coastal waters. Others were designed specifically for catching lobsters and, therefore, for use a greater distance from the shore and at greater depths. The latter traps require greater structural strength to withstand the handling and the environmental conditions above and below the sea. Generally, those collapsible lobster traps are made of numerous and complicated parts.

Some of the more recent collapsible-trap designs provide for a reduction in the required number of parts as well as for an apparent simplification of the structure overall. However, both the earlier devices and some of the recent ones suffer major disadvantages as the result of providing only one chamber for holding the catch and of providing fixed tunnel entrance units—called heads—which must be removed and stored separately. Both features are unacceptable in a trap to be used for fishing in the Northeast. Specifically, a single chamber is undesirable when trying to catch lobsters because the trap is often left in the water for several days. With only one chamber the chance for a lobster to escape is greatly increased. As a result, most, if not all, traps used for lobstering in that part of the country include several chambers so that escape is much less likely. In addition, the use of a plurality of chambers increases the likelihood that greater numbers of lobsters will be retained, as lobsters tend to move from an entry chamber to bait retained in back chambers “deeper” in the trap. With regard to the fixed heads that must be removed and stored separately, such manipulation greatly increases the length of time required to deploy or remove each trap. That cuts into the effective fishing time available and is therefore unacceptable, particularly as fishing time periods are limited by weather, seasons, and regulation.

More recent collapsible traps have been devised in various shapes having pyramidal, circular, octagonal, and rectangular designs. U.S. Pat. No. 4,982,525 (1991, Miller) teaches a collapsible lobster or crab trap having a pyramidal shape with a triangular base and three triangular sides. Miller provides for two net-head entrances and a single-room trap. Its pyramidal shape allows for problem-free trap retrieval upward through kelp or seaweed.

U.S. Pat. No. 4,864,770 (1989, Serio) teaches a collapsible crustacean trap having rectangular top and bottom panels made of wire and hinged to side panels which are, in turn, themselves hinged in the middle. Serio provides for a single room and a single net-head entrance.

U.S. Pat. No. 4,509,288 (1985, Shepherd) teaches a shellfish trap having octagonal top and bottom panels made of wire. Shepherd provides for two rigid wire-mesh entrances for the shellfish with attached wire-mesh doors leading to a single room. Although the Shepherd trap was designed for easy assembly and can be broken down into component parts, the large number of component parts makes it impractical from the user's viewpoint.

U.S. Pat. No. 3,245,173 (1966, Sylvester) teaches a lobster pot made of a lightweight material yet requires relatively little ballast to keep it submerged. Sylvester provides for two recessed but rigid entrances and a single room for holding the catch. Absent from the Sylvester device is a means for preventing the entrapped catch from leaving through the entrance openings.

Even though these previous devices all purport to address the goal of either the collapsibility of the trap or the ease of assembly of the trap, they nevertheless suffer from key disadvantages. All of these previous devices overlook the need for a multi-room trap for accommodating larger numbers of lobster and for increasing the difficulty of escape over a limited period of time. In addition, they do not address the degree of ruggedness required for the trap once it is assembled and in use, taking account of the combined weight of the lobster, the trap, the hauling conditions, and the ballast needed to properly anchor the trap on the ocean floor. All of these deficiencies render those prior traps unacceptable by present lobstermen. Essentially the only type of “new” trap, including the type that is collapsible, that is likely to gain acceptance is the type that looks and operates like currently-available traps. To date, that has not been achieved, particularly in the field of collapsible traps.”

The invention of the United States Patent is directed to a solution to a different problem to that of the present invention, although it has some similar objects. The present invention is generally directed to providing a trap which a non-commercial trapper can easily use, but trap the prawns more effectively, especially when the trap is being recovered from its set position.

It will be clearly understood that, if a prior art publication is referred to herein, this reference does not constitute an admission that the publication forms part of the common general knowledge in the art in Australia or in any other country.

### SUMMARY OF THE INVENTION

The present invention is directed to a trap for marine life, which may at least partially overcome at least one of the abovementioned disadvantages or provide the consumer with a useful or commercial choice.

In one form, the invention resides in a trap for marine life including an upper member, a lower member, at least one separating means to retain the upper member spaced from the lower member and defining an opening therebetween, and at least one side wall member movable between a lowered, open condition and a raised, closed condition wherein the wall member substantially closes the opening between the upper member and the lower member.

In particular, this trap for marine life may be more efficiently adapted to more effectively cage the animals during the process of recovering the trap. The trap is designed to be used to trap prawns in particular, but it can be used to catch other marine creatures such as crayfish or crabs or the like. Each of these types of creatures generally moved in a sedate manner but when surprised, they are capable of short bursts of very quick movement which allows them to escape conventional traps.

The trap of the present invention will generally be used on a non-commercial basis by weekend anglers attempting to catch enough seafood for a meal or two. The trap could be used on a commercial basis but the requirement of moving the wall member to close the trap of the present invention is unlikely to find acceptance with commercial fishermen as it may lack the efficiency of the large bag-like nets.

Typically, the trap is set in an appropriate location with the wall member in the lowered condition leaving an opening through which the marine creatures can enter the trap. An attractant such as berley or other foodstuff suitable for prawns of the like may be placed in the trap on or adjacent the lower member. After waiting an appropriate period of time to attract the marine creatures and before attempting to raise the trap, the wall member is moved to the raised condition, closing the trap and preventing the egress of the marine life which are located above the lower member.

Suitably, there will be a means for moving the side wall member between the lowered and raised condition. Typically, traps such as that of the present invention are set underwater and they are maintained in location by attaching a rope or similar binding means to a float or buoy that has been securely anchored to the underwater ground surface. When the trap is retrieved, the user simply pulls the rope upward until the trap appears. In the case of the present invention, the means for moving the side wall member may be, or be associated with, the rope used to recover the trap. There will generally be a single rope or line which is divided into or associated with a number of rope or lines so that when the rope or line is pulled upwardly to close the trap, the side wall member is raised in a balanced and not lopsided manner.

The trap includes an upper member. This upper member will normally be a substantially planar member, but it may be of any configuration that prevents the egress of trapped marine creatures.

The upper member may be of any shape. It has been found in the field marine traps that most traps are either circular or rectangular in cross-section and it is anticipated that one of these shapes will be preferred for the present invention.

The upper member will generally have at least one substantially rigid, shape—defining member or rim member. Each rim member may be manufactured of a plastic material in order to reduce the weight of the trap and to minimise damage from the water but any suitable material may be used.

Attached to the rim members using any appropriate fastening technique may be a net or mesh member. Together with the rim members, the mesh member may form the upper member. Mesh is used to allow the water to drain through the trap during recovery and setting but also to prevent the egress of the marine creatures inside the trap. The mesh can be attached to the rim members by adhesive or using twine, string or a similar line member to attach it. The mesh member will generally be tightly stretched between the rim members.

The trap further includes a lower member. This lower member will normally be a substantially planar member, but it may be of any configuration that prevents the egress of trapped marine creatures. It is anticipated that the lower member may have alternative configurations such as conical (downwardly converging) to concentrate the catch and allow more efficient removal.

The lower member may be of any shape. It has been found in the field marine traps that most traps are either circular or rectangular in cross-section and it is anticipated that one of these shapes will be preferred for the present invention.

The lower member will generally have at least one substantially rigid, shape—defining member or rim member. Each rim member may be manufactured of a plastic material in order to reduce the weight of the trap and to minimise damage from the water but any suitable material may be used.

Attached to the rim members using any appropriate fastening technique may be a net or mesh member. Together with the rim members, the mesh member may form the upper member. Mesh is used to allow the water to drain through the trap during recovery and setting but also to prevent the egress of the marine creatures inside the trap. The mesh can be attached to the rim members by adhesive or using twine, string or a similar line member to attach it. The mesh member will generally be tightly stretched between the rim members.

The trap further includes at least one separating means to retain the upper member spaced from the lower member and defining an opening therebetween. Typically, there will be a plurality of separating means spaced about the trap. Each separating means will typically be located towards the outer periphery of the trap. Most suitably, the separating means will extend between the rim member of the upper member and the rim member of the lower member.

Each separating means will preferably include a plurality of arm members. The arm members will generally be configured in sets or pairs with one of the pair of arm members associated with the upper member and the other of the pair of arm members associated with the lower member. At least one of the arm members of each pair will typically be hollow.

The arm members of the upper member and the arm members of the lower member are typically of the same cross-section and are also correspondingly dimensioned such that one of the pair or set of arm members is engageable with the other of the pair or set to allow the trap to assume an assembled condition in which the upper and lower members attached relative to one another and are spaced apart and a collapsed condition in which the upper and lower members are separate from one another.

Each of the pair of arm members are engageable with the other of the pair by means of one of the pair of arm members being closely received within the other of the pair in an interference fit.

The trap also includes at least one side wall member. The side wall member is typically movable between a lowered condition in which the trap is open and a raised condition wherein the wall member substantially closes the opening between the upper member and the lower member.

The side member will typically be formed of a net or mesh material. The side member will typically be attached to the lower member, preferably the rim member of the lower member. The at least one side member will generally have at least one substantially rigid, shape—defining member or rim member. Typically, the side member may have an upper rim member and a middle rim member. Each rim member may be manufactured of a plastic material in order to reduce the weight of the trap and to minimise damage from the water but any suitable material may be used. The side wall member may be raised or lowered to close the trap.

Attached to the rim members using any appropriate fastening technique may be a side mesh member. The side mesh member will typically be flexible as is the mesh member of all members of the trap of the present invention.

Together with the rim members, the side mesh member may form the side wall member. Mesh is used to allow the water to drain through the trap during recovery and setting but also to prevent the egress of the marine creatures inside the trap when the wall is in the raised condition. The mesh can be attached to the rim members by adhesive or using twine, string or a similar line member to attach it.

The rim members of the side wall member may additionally be provided with guide means. The guide means will generally engage with respective pairs of arm members to maintain the side wall member in position as it is moved between the lowered and raised condition and to minimise or prevent fouling of the side wall member, particularly the mesh portion thereof, by catching the side wall member on protrusions of the trap. The guide means is typically in the form of a closed ring which is placed around the arm members when the trap is assembled. There will typically be one guide means for each pair of arm members. The guide means may be integrally formed with the rim members.

The rim members of the upper member or the upper arm member in each pair may additionally be provided with guide means to minimise or prevent fouling of the means for moving the side wall member between the lowered and raised condition, by catching the rope or line on protrusions of the trap. The guide means will again typically be a closed ring through which the line for moving the side wall member extends. There will typically be a guide means for each pair of arm members and each guide means will generally be located at an upper portion of the trap.

The trap itself may have overall dimensions of approximately 1 metre in diameter when circular and approximately 150 mm in height when assembled. The arm members are typically formed of polyvinyl chloride plastic. The rope or line used to retrieve the trap and move the side wall member between the lowered and raised conditions will generally be quite thin and preferably be about 3 mm in diameter.

All components of the trap, including the mesh used, will suitably be manufactured from plastic material to prevent corrosion when the trap is used in salt water.

### BRIEF DESCRIPTION OF THE DRAWINGS

Various embodiments of the invention will be described with reference to the following drawings, in which:

FIG. 1 is a schematic perspective view of a trap according to a preferred embodiment of the present invention.

FIG. 2 is a perspective view of a trap according to a preferred embodiment of the present invention in the assembled condition with the side wall lowered.

FIG. 3 is a side view of the trap illustrated in FIG. 2.

FIG. 4 is a side view of the trap illustrated in FIG. 2 in a partially disassembled condition.

FIG. 5 is a perspective view of the trap illustrated in FIG. 2 in a disassembled condition.

FIG. 6 is a perspective view of the trap illustrated in FIG. 2 with the side wall raised.

FIG. 7 is a perspective view of the trap illustrated in FIG. 6 showing the means for retrieving the trap.

### DETAILED DESCRIPTION OF THE PREFERRED EMBODIMENT

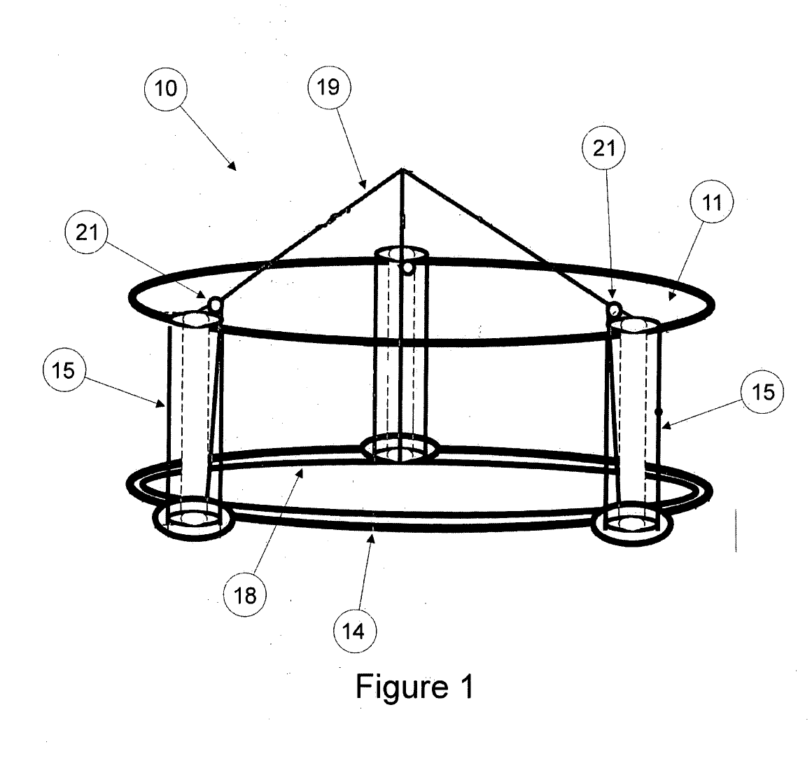

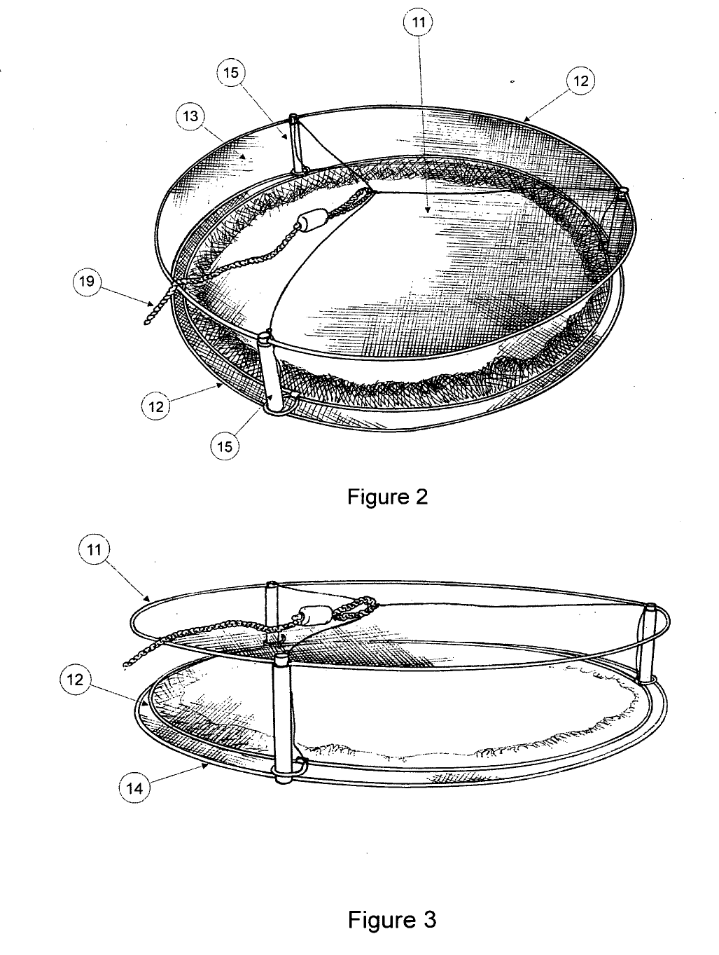

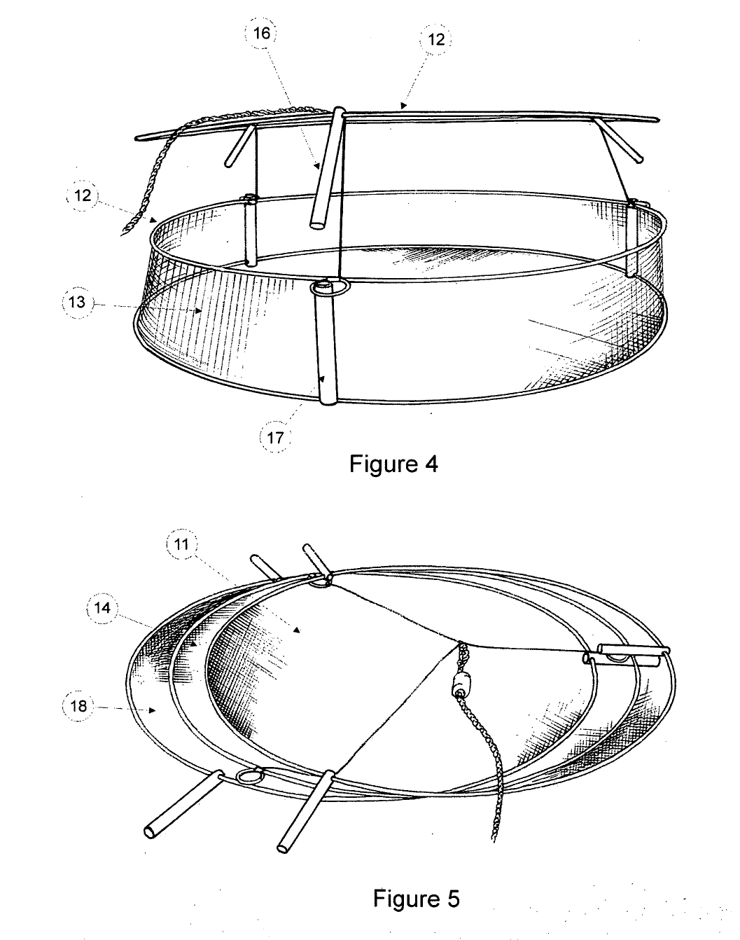

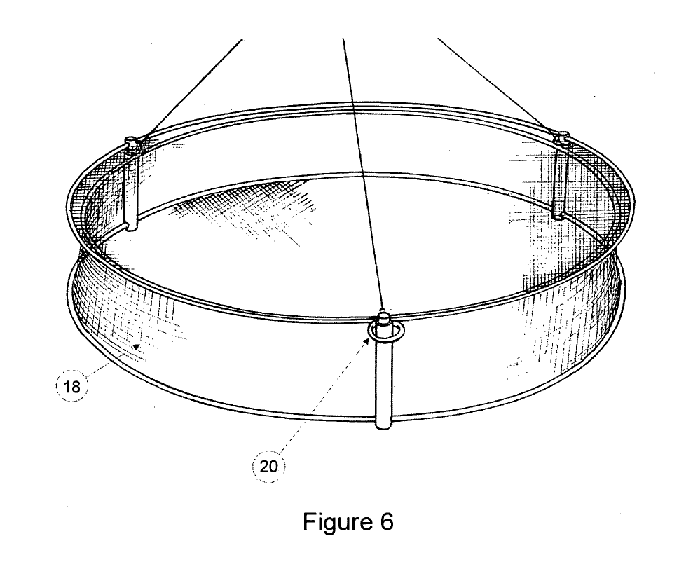

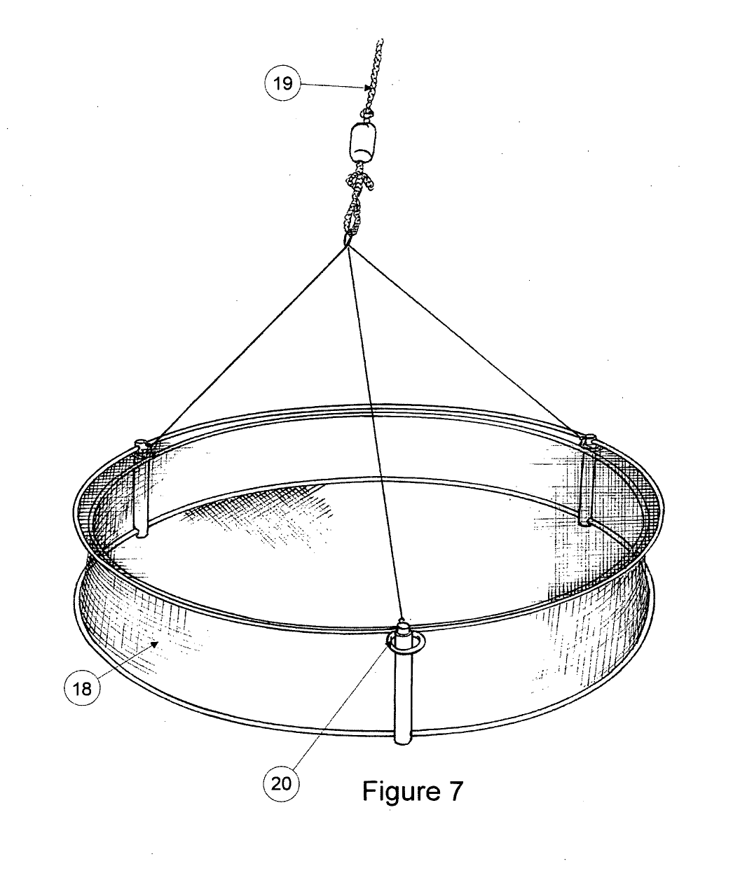

According to a preferred embodiment of the present invention, a trap 10 for marine life is provided as illustrated in FIG. 1 to 7.

The trap 10 includes an upper member 11. This upper member 11 is a substantially planar member rigid rim member 12 which defines an opening and mesh 13 extends across the opening. The rim member 12 is manufactured of a plastic material in order to reduce the weight of the trap 10 and to minimise damage from the water.

The mesh 13 is attached to the rim member 12 by adhesive or using twine, string or a similar line member to attach it. The mesh 13 is tightly stretched between the rim member 12.

The trap 10 includes a lower member 14. This lower member 14 is a substantially planar member rigid rim member 12 which defines an opening and mesh 13 extends across the opening. The rim member 12 is manufactured of a plastic material in order to reduce the weight of the trap 10 and to minimise damage from the water.

The mesh 13 is attached to the rim member 12 by adhesive or using twine, string or a similar line member to attach it. The mesh. 13 is tightly stretched between the rim member 12.

The trap 10 further includes a plurality of separating arms 15 to retain the upper member 11 spaced from the lower member 14 and defining an opening therebetween. Each of the separating arms 15 is located towards the outer periphery of the trap 10 and extends between the rim member 12 of the upper member 11 and the rim member 12 of the lower member 14.

Each separating arm 15 includes a pair of arm members with one of the pair of arm members, the upper arm member 16 associated with the upper member 11 and the other of the pair of arm members, the lower arm member 17 associated with the lower member 14. According to the preferred embodiment, the lower arm member 17 of each pair is hollow.

The arm members are of the same cross-section and are also correspondingly dimensioned such that the upper arm member 16 can be received within with the lower arm member 17 to allow the trap 10 to assume an assembled condition in which the upper 11 and lower 14 members are attached relative to one another and are spaced apart and a collapsed condition (illustrated in FIG. 5) in which the upper 11 and lower 14 members are separated from one another.

The trap 10 also includes a side wall member 18. The side wall 18 member of the preferred embodiment is movable between a lowered condition in which the trap 10 is open and a raised condition wherein the side wall member 18 substantially closes the opening between the upper member 11 and the lower member 14.

The side wall member 18 is formed of a net or mesh material and is attached to the rim member 12 of the lower member 14. The side wall member 18 has a substantially rigid rim member 12 and the mesh is attached to the rim member 12 of the side wall member 18 and the rim member 12 of the lower member 14.

There is also provided, a rope or line 19 for moving the side wall member 18 between the lowered and raised condition. Typically, traps such as that of the present invention are set underwater and they are maintained in location by attaching a rope or similar binding means to a float or buoy that has been securely anchored to the underwater ground surface. When the trap is retrieved, the user simply pulls the rope upward until the trap appears. In the case of the present invention, the means for moving the side wall member may be, or be associated with, the rope used to recover the trap. There is a single rope or line 19 which is divided into a number of rope or lines adjacent the trap itself, so that when the rope or line 19 is pulled upwardly to close the trap, the side wall member 18 is raised in a balanced and not lopsided manner.

The rim members 12 of the side wall member 18 are provided with guide means 20. The guide means 20 engage with the separating arms 15 to maintain the side wall member 18 in position as it is moved between the lowered and raised condition and to minimise or prevent fouling of the side wall member, particularly the mesh portion thereof, by catching the side wall member on protrusions of the trap. The guide means 20 is a closed ring which is placed around the arm members 15 when the trap is assembled. There is a guide means 20 for each pair of arm members and the guide means 20 is integrally formed with the rim member 12.

The rim members 12 of the upper member 11 or the upper arm member in each pair may additionally be provided with rope guide means 21 to minimise or prevent fouling of rope 19, by catching the rope 19 on protrusions of the trap. The rope guide means 21 is a closed ring through which the line for moving the side wall member extends. There is a rope guide means 21 for each separating arm 15 and each guide means is located at an upper portion of the trap 10.

The trap itself may have overall dimensions of approximately 1 metre in diameter when circular and approximately 150 mm in height when assembled. The arm members are formed of polyvinyl chloride plastic. The rope or line used to retrieve the trap and move the side wall member between the lowered and raised conditions will generally be quite thin and usually about 3 mm in diameter.

In particular, this trap for marine life may be more efficiently adapted to more effectively cage the animals during the process of recovering the trap. The trap is designed to be used to trap prawns in particular, but it can be used to catch other marine creatures such as crayfish or crabs or the like. Each of these types of creatures generally moved in a sedate manner but when surprised, they are capable of short bursts of very quick movement which allows them to escape conventional traps.

The trap of the present invention will generally be used on a non-commercial basis by weekend anglers attempting to catch enough seafood for a meal or two. The trap could be used on a commercial basis but the requirement of moving the wall member to close the trap of the present invention is unlikely to find acceptance with commercial fishermen as it may lack the efficiency of the large bag-like nets.

Typically, the trap is set in an appropriate location with the wall member in the lowered condition leaving an opening through which the marine creatures can enter the trap. An attractant such as berley or other foodstuff suitable for prawns of the like may be placed in the trap on or adjacent the lower member. After waiting an appropriate period of time to attract the marine creatures and before attempting to raise the trap, the wall member is moved to the raised condition, closing the trap and preventing the egress of the marine life which are located above the lower member.

In the present specification and claims, the word “comprising” and its derivatives including “comprises” and “comprise” include each of the stated integers but does not exclude the inclusion of one or more further integers.

Reference throughout this specification to “one embodiment” or “an embodiment” means that a particular feature, structure, or characteristic described in connection with the embodiment is included in at least one embodiment of the present invention. Thus, the appearance of the phrases “in one embodiment” or “in an embodiment” in various places throughout this specification are not necessarily all referring to the same embodiment. Furthermore, the particular features, structures, or characteristics may be combined in any suitable manner in one or more combinations.

In compliance with the statute, the invention has been described in language more or less specific to structural or methodical features. It is to be understood that the invention is not limited to specific features shown or described since the means herein described comprises preferred forms of putting the invention into effect. The invention is, therefore, claimed in any of its forms or modifications within the proper scope of the appended claims appropriately interpreted by those skilled in the art.

1. A trap for marine life including an upper member, a lower member, at least one separating means to retain the upper member spaced from the lower member and defining an opening therebetween, and at least one side wall member movable between a lowered, open condition and a raised, closed condition wherein the wall member substantially closes the opening between the upper member and the lower member.

2. A trap for marine life according to claim 1 further including a means for moving the side wall member between the lower and raised condition.

3. A trap for marine life according to claim 2 wherein the means for moving the side wall member includes a single rope or line which is divided into or associated with a number of rope or lines such that when the single rope or line is pulled upwardly to close the trap, the side wall member is raised in a balanced manner.

4. A trap for marine life according to claim 1 wherein said upper member includes at least one substantially rigid rim member defining an opening with a mesh member extending across the opening.

5. A trap for marine life according to claim 1 wherein said lower member includes at least one substantially rigid rim member defining an opening with a mesh member extending across the opening.

6. A trap for marine life according to claim 4 wherein the mesh member is stretched tightly across the opening.

7. A trap for marine life according to claim 5 wherein the mesh member is stretched tightly across the opening.

8. A trap for marine life according to claim 1 wherein there are a plurality of separating means spaced about the trap and located towards an outer periphery of the trap.

9. A trap for marine life according to claim 6 wherein the at least one separating means extends between the rim member of the upper member and the rim member of the lower member.

10. A trap for marine life according to claim 9 wherein the at least one separating means includes a pair of arm members with one of the pari of arm members associated with the upper member and the other of the pari of arm members associated with the lower member.

11. A trap for marine life according to claim 10 wherein at least one of the arm members of each pair is hollow and the arm members of a pair are correspondingly dimensioned such that one of the pair or set of arm members is engageable with the other of the pair or set to allow the trap to assume an assembled condition in which the upper and lower members are attached relative to one another and are spaced apart and a collapsed condition in which the upper and lower members are separate from one another.

12. A trap for marine life according to claim 10 wherein the arm members are engageable by means of one of the pair of arm members being closely received within the other of the pair in an interference fit.

13. A trap for marine life according to claim 11 wherein the at least one side member is formed of a mesh material attached to the lower member.

14. A trap for marine life according to claim 13 wherein the at least one side member has at least one substantially rigid rim member with the mesh material extending between the rim member of the at least one side wall member and the lower member.

15. A trap for marine life according to claim 13 wherein the at least one side member has an upper rim member.

16. A trap for marine life according to claim 14 wherein the rim members of the side wall member are provided with guide means to maintain the side wall member in position as it is moved between the lowered and raised condition and to minimize or prevent fouling of the side wall member.

17. A trap for marine life according to claim 16 wherein the guide means a closed ring formed integrally with the rim member and which engages with the at least one separating means.

18. A trap for marine life according to claim 2 wherein guide means is provided to minimize or prevent fouling of the means for moving the side wall member between the lowered and raised condition.
